(19) United States
(12) Patent Application Publication
(10) Pub. No.: US 2002/0071336 A1
(43) Pub. Date: Jun. 13, 2002

(54) Concrete mixer with interior coating and method

(76) Inventors: Stephen W. Smith, Dallas, TX (US); Robert A. Aamodt, Keller, TX (US)

Correspondence Address: James A. Wilke, FOLEY & LARDNER, Firstar Center, 777 East Wisconsin Avenue, Milwaukee, WI, 53202-5367, US

(21) Appl. No.: 09/918,305

(22) Filed: Jul. 30, 2001

Related U.S. Application Data
(60) Provisional application No. 60/221,786, filed on Jul. 31, 2000.

(51) Int. Cl. B28C 5/20; B28C 5/42

(52) U.S. Cl. 366/59

(57) ABSTRACT

An interior coating for use on the interior surface of a concrete mixing drum including a mixing fin employed therein. The interior coating preferably protects the interior surface of the drum from severe service including abrasion, wear and corrosion. The interior coating provides a generally smooth and essentially slippery surface to improve discharge of concrete mix as well as to provide complete cleanout of the residual mix remaining in the drum.

### CROSS-REFERENCE TO A PROVISIONAL APPLICATION

This application claims the benefit of U.S. Provisional Application No. 60/221,786, filed Jul. 31, 2000.

### BACKGROUND OF THE INVENTION

The present invention relates generally to concrete mixers and, more particularly, to a concrete mixer having an interior coating which enhances cleanout as well as protects of the concrete mixer interior from abrasion, wear and corrosion.

Concrete mixers have been in service for many years. However, the service life of any one concrete mixer can vary and is often determined by the rigors of service to which it is exposed. During the life of a concrete mixer, the mixer itself, generally including a tank or drum, interior surfaces of the tank or drum, fins mounted on the interior of the tank or drum, the motor, etc. experiences the most wear. Concrete mix generally includes cement, sand and gravel or rock of some form provided in generally large quantities. Water is added to the concrete mixture prior to use. As can be expected, the constant churning and mixing of large quantities of concrete mix has significant wear effects on the mixer and, in particular, on interior surfaces and components such as fins mounted therein.

In addition to the problems of wear, corrosion, abrasion, etc., it is not uncommon for residual concrete mix to remain in the drum once a mixer has discharged its load. The cleanout of this residual mix has long required substantial effort and labor on the part of a concrete mixer operator. As a result, some cleanout techniques have been blamed for effecting their own damage to the interior of the drum.

Current attempts to address the aforementioned problems have been generally unsatisfactory. For example, abrasion resistant steel or other hardened wear surfaces have been employed to manufacture drums. However, these attempts at solving the problem only address a small portion of the overall concern. Sacrificial bars and plastic fins have also been employed to address such common concrete mixer problems but, again, only a portion of the problem is addressed and the attempted solutions often create additional problems in other areas.

### SUMMARY OF THE INVENTION

There is provided a concrete transport vehicle comprising a chassis having a front end and a rear end. A mixing drum is supported by the chassis. The mixing drum has an interior surface with an interior coating disposed thereon, a first end and a second end and an opening in communication with the interior surface of the mixing drum. The hopper is coupled to the drum. A pedestal extends between the chassis and one end of the drum to support that end of the drum. The chassis also supports a cab enclosure. A main chute is coupled to the hopper. The interior coating can be formed from flexible, abrasion-resistant material such as polyurea, elastomeric urethanes, modified and hybrid epoxies that are glass plates reinforced, modified and hybrid epoxies containing polytetrafluoroethylene type fillers and ceramic epoxy coating systems.

There is also provided a concrete mixer comprising a hollow tank having an interior surface and at least one opening for adding contents and discharging contents therefrom. The interior surface of the hollow tank is coated with an interior coating. Another embodiment of the concrete mixer can have a mixing fin mounted on the interior surface of the tank. The mixing fin is also coated with the interior coating.

There is a also provided a method for enabling the clean out of a concrete mixer comprising the steps of providing a hollow tank having an interior surface and at least one opening for adding and discharging contents therefrom. Applying a coating to the interior surface of the tank and allowing the coating to cure before adding the contents to the tank. Another embodiment of the method includes applying the coating by spraying on the interior surface of the tank.

### BRIEF DESCRIPTION OF THE DRAWINGS

FIG. 1 is a side plan view of the front discharge concrete transport vehicle including an exemplary embodiment of a concrete mixer having an interior coating.

FIG. 2 is a side plan view of a rear discharge concrete transport vehicle including an exemplary embodiment of a concrete mixer having an interior coating.

FIG. 3 is a side elevation illustration of an exemplary embodiment of a mixing drum and illustrating exemplary embodiments of mixing fins mounted on the interior surface of the drum.

FIG. 4 is a partial sectional view of the drum illustrated in FIG. 3 along the line 4-4.

### DETAILED DESCRIPTION OF THE PREFERRED EMBODIMENTS

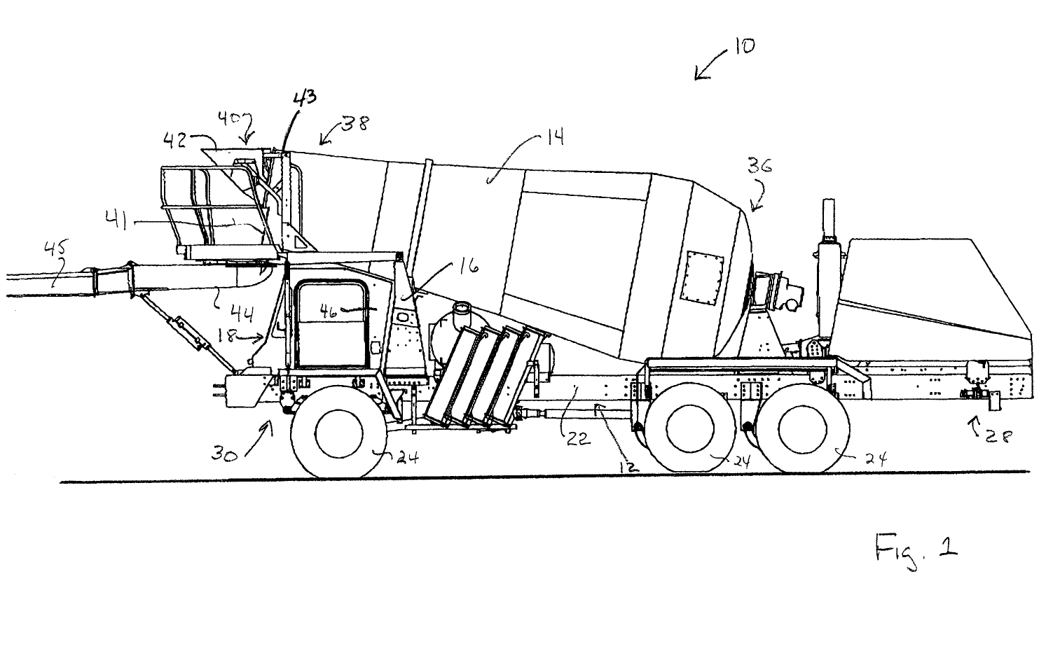

FIG. 1 illustrates a front discharge concrete transport vehicle 10 configured to mix, transport and pour concrete. Vehicle 10 generally includes chassis 12, mixing drum 14, pedestal 16, and cab enclosure 18. Chassis 12 supports mixing drum 14, pedestal 16, cab enclosure 18 and conventionally known engine, transmission and hydraulic systems (not shown) of vehicle 10. Chassis 12 includes frame 22 and wheels 24. Frame 22 extends from a rear end 28 to a front end 30 of vehicle 10 and is coupled to wheels 24. Frame 22 provides a structural base for supporting drum 14, pedestal 16 and chassis 18. Frame 22 includes a widened front portion 34 which extends over and about forward most wheels 24 to simultaneously support cabin enclosure 18 and to serve as a fender for the forward most wheels 24. Frame 22 is preferably formed from heat treated carbon manganese steel.

Wheels 24 moveably support frame 22 above the ground or terrain. As will be appreciated, wheels 24 may be replaced by other ground engaging motive members such as tracks.

Concrete transport vehicle 10 is only one example of the wide variety of concrete mixers which may have interior surfaces and components coated in accordance with the coatings and methods, and their respective equivalents described herein. Other examples include, but are not limited to, concrete batch plants and concrete mixers mounted on vehicles other than trucks.

Mixing drum 14 is conventionally known and is supported by frame 22 of chassis 12. Drum 14 has a first end 36 towards rear 28 and a second end 38 towards front 30 of vehicle 10. Second end 38 extends above cab enclosure 18 and includes an opening 40 through which concrete is emptied from drum 14 into the discharge hopper 41 and main chute 44 as well as extension chutes 45 (shown connected to the main chute 44), for distribution of concrete forward front 30 of vehicle 10. Drum 14 is rotated in a conventionally known manner to mix concrete until being emptied through opening 40 into discharge hopper 41 and chute 44. Because opening 40, discharge hopper 41 and chute 44 extend above cab enclosure 18 and forward front end 30 of vehicle 10, concrete vehicle 10 is better able to supply concrete to hard to reach and otherwise inaccessible locations.

Charging hopper 42 is preferably operable to be repositioned. As such, charging hopper 42 may be pivoted or displaced about a pivot point on bracket 43 to allow such repositioning. Other methods and apparatuses for repositioning. Other methods and apparatuses for repositioning charging hopper 42 are considered within the scope of the present claims.

One position which charging hopper 42 may assume is a first or charging position. In its first or charging position, as illustrated in FIG. 1, charging hopper 42 preferably allows wet concrete, the materials, cement, water and gravel, to make concrete, and/or other materials to be placed into drum 14 through a drum opening preferably included thereon. During charging of drum 14, i.e., when charging hopper 42 is in its first, charging position, an environmental shield preferably disposed thereon may be employed to reduce the amount of leakage or spillage commonly experienced during drum 42 charging operations.

Pedestal 16, also known as a support post or support column, comprises part of the super structure of vehicle 10 and extends between frame 22 of chassis 12 and end 38 of drum 14. Pedestal 16 supports end 38 of drum 14 above cab enclosure 18.

Cab enclosure 18 includes housing 46 supported by frame 22 of chassis 12 below end 38 of drum 14.

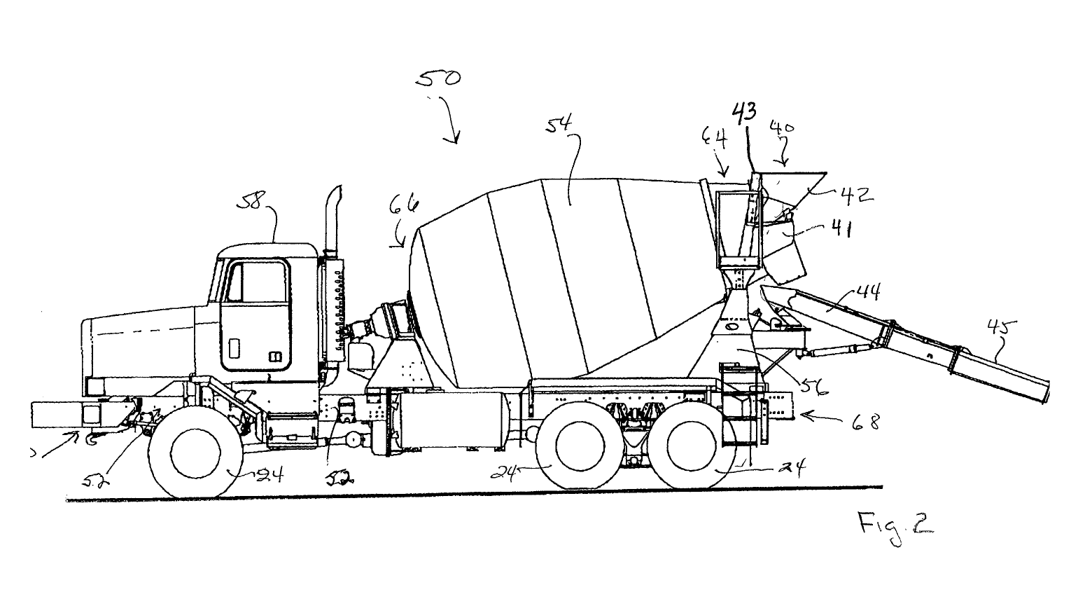

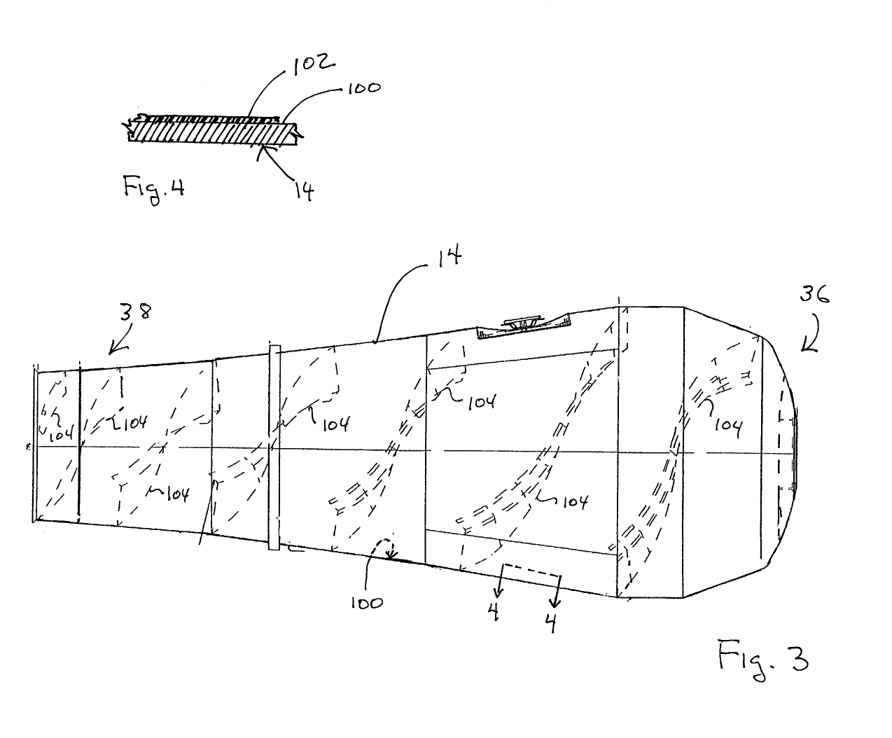

FIG. 2 to illustrate a rear discharge concrete transport vehicle 50 configured to mix, transport and pour concrete. Vehicle 50 generally includes chassis 52, mixing drum 54, pedestal 56, and cab enclosure 58. Chassis 52 supports mixing drum 54, pedestal 56, cab enclosure 58 and conventionally known engine, transmission and hydraulic systems (not shown) of vehicle 50. Chassis 52 includes frame 62 and wheels 24. Frame 62 extends from a rear end 68 to a front end 70 of vehicle 50 and is coupled to wheels 24. Frame 62 provides a structural base for supporting drum 54, pedestal 56 and chassis 58. Frame 62 is preferably formed from heat treated carbon manganese steel.

Wheels 24 moveably support frame 62 above the ground or terrain. As will be appreciated, wheels 24 may be replaced by other ground engaging motive members such as tracks.

Concrete transport vehicle 50 is only one example of the wide variety of concrete mixers which may have interior surfaces and components coated in accordance with the coatings and methods, and their respective equivalents described herein. Other examples include, but are not limited to, concrete batch plants and concrete mixers mounted on vehicles other than trucks.

Mixing drum 54 is conventionally known and is supported by frame 62 of chassis 52. Drum 54 has a first end 64 towards rear 68 and a second end 66 towards front 70 of vehicle 50. Second end 66 includes an opening 40 through which concrete is emptied from drum 54 into charge hopper 42 and main chute 44 as well as extension chutes 45 (shown connected to the main chute 44), for distribution of concrete to rear 70 of vehicle 50. Drum 54 is rotated in a conventionally known manner to mix concrete until being emptied through opening 40 into discharge hopper 41 and chute 44.

One position which charging hopper 42 may assume is a first or charging position. In its first or charging position, as illustrated in FIG. 2, charging hopper 42 preferably allows wet concrete, the materials, cement, water and gravel, to make concrete, and/or other materials to be placed into drum 1 4 through a drum opening preferably included thereon. During charging of drum 14, i.e., when charging hopper 42 is in its first, charging position, an environmental shield preferably disposed thereon may be employed to reduce the amount of leakage or spillage commonly experienced during drum 42 charging operations.

Pedestal 56, also known as a support post or support column, comprises part of the super structure of vehicle 50 and extends between frame 62 of chassis 52 and end 64 of drum 54. Pedestal 56 supports end 64 of drum 54.

Cab enclosure 58 includes housing 59 supported by frame 62 of chassis 52 in front of end 66 of drum 54.

During travel of truck 10, (It should be understood that the following description is also applicable to the rear discharge vehicle 50 and to any mobile platform that the mixing drum is mounted.) such as after charging drum 14, in route to a job site, charging hopper 42 may be maintained in the first or charging position illustrated in FIG. 1. Maintaining charging hopper 42 in its first or charging position preferably maintains an environmental shield coupled thereto in generally sealed engagement with a drum opening 40 included on drum 14. As a result and in such instances as the surging of contents contained in drum 14 or the travel of concrete mixer truck 10 over sloped or hilly terrain, maintaining charging hopper 42 in its first position enables the environmental shield to prevent or reduce leakage of contents from drum 14.

During the discharge of contents from drum 14, such as at a job site, charging hopper 42 is preferably displaced from the rear opening 40 of drum 14. Such a displacement of charging hopper 42 generally involves pivoting charging hopper 42 about bracket 43 such that charging hopper 42 may come to rest in its second position above or aside drum 14 and clear of the drum opening 40 preferably included thereon.

In accordance with teachings disclosed herein, the interior surface 100 of drum 14 is provided with a coating operable to improve its life, wear and other operating characteristics. Accordingly, the interior surface 100 of drum 14 may be coated with one of a variety of coatings 102. Preferably included in the coating of the interior of drum 109, is the coating 102 of generally all structures commonly incorporated on the interior surface 100 of drum 14. Such structure may include, but are not limited to, mixing fins 104.

The interior coating 102 employed in drum 14 preferably contains a variety of characteristics that have significant benefits associated with each. Such characteristics may include resistance to abrasion, impact, corrosion and chemicals. In addition, the interior coating 102 used on the interior surface 100 of drum 14 preferably has the characteristic of high thermal stability.

The preferred interior coating 102 is also generally flexible. A generally flexible interior coating preferably allows the underlying structure to flex without damaging the interior coating 102, particularly at the joints within the drum 14. The ability to achieve a seamless interior coating 102 will contribute significantly to a reduction in maintenance expenses as well as contribute many additional advantages. An example of one method of applying the interior coating 102 to the interior surface 100, including a mixing fin 104, of a mixing drum 14 is by spraying.

In part to reduce the labor involved in applying an interior coating 102 to the interior surface 100 of drum 14, a variety of application characteristics are preferably associated with the interior coating 102 employed. For example, the interior coating 102 used to coat the interior surface 100 of drum 14 preferably easily and reliably adheres to steel or other material used to manufacture drum 14. In addition, it is preferred that the interior coating 102 used to coat the interior surface 100 of drum 14 be applicable in confined spaces and that it meets applicable regulations concerning volatile organic compounds.

Similarly, time out of service is a factor for consideration when selecting the type of interior coating 102 to be used on the interior surface 100 of drum 14. As such, many of the interior coatings considered have minimal application time requirements. For example, the reactivity and cure time of an elastomeric polyurea interior coating is generally in the range of one to three hours.

Ease of discharge and cleanout of the mixing drum 14 may be achieved by using an interior coating that, once applied, provides a generally smooth and essentially slippery surface. Smooth and slippery characteristics may also contribute to prolonging the life of the drum 14 as well as the life of the mixing fins 104 typically mounted therein. Reduced maintenance costs may also be realized by applying an interior coating 102 to concrete mixing drum 14.

Application of an interior coating 102 to drum 14 may be achieved using any of a variety of methods. In fact, the method preferred may be determined by the interior coating 102 employed. Similarly, application of an interior coating 102 to drum 14 may occur at manufacture, at a concrete company's facilities, or at some other point. Therefore, the present invention is not limited to any particular method for applying an interior coating 102.

The present invention considers many different compounds or mixtures for use as an interior coating 102 from drum 14. Examples of compounds which posses many of the characteristics mentioned above include, but are not limited to, polyurea, elastomeric urethanes, modified or hybrid epoxies containing glass flakes or polytetrafluroethylene type fillers (such as Teflon®) and ceramic epoxy coatings.

In addition, drum 14 of transit mixer 10 is one of many concrete mixing apparatuses which may benefit from the present disclosure. Additional structures which may benefit from herein include, but are not limited to, silos, freestanding concrete mixers, etc.

Although the disclosed embodiments have been described in detail, it should be understood that various changes, substitutions and alterations can be made to the embodiments without departing from their spirit and scope.

What is claimed is:

1. A concrete transport vehicle comprising:
a chassis having a front end and a rear end;
a mixing drum supported by the chassis, the drum having an interior surface with an interior coating disposed thereon, a first end and a second end and an opening in communication with the interior surface;
a hopper coupled to the drum;
a pedestal extending between the chassis and one end of the drum to support that end of the drum,
a cab enclosure supported by the chassis and,
an main chute coupled to the hopper.

2. The vehicle of claim 1, wherein the mixing drum is configured to discharge concrete from one of the first end and the second end.

3. The vehicle of claim 1, wherein the interior coating formed from flexible, abrasion resistant material.

4. The vehicle of claim 3, wherein the interior coating formed from material selected from a group consisting of polyurea, elastomeric urethanes, modified and hybrid epoxies that are glass flake reinforced, modified and hybrid epoxies containing polytetrafluoroethylene type fillers and ceramic epoxy coating systems.

5. The vehicle of claim 1, including a mixing fin mounted on the interior surface of the mixing drum.

6. The vehicle of claim 5, wherein the mixing fin is coated with the interior coating.

7. A concrete mixer comprising:
a hollow tank having an interior surface and at least one opening for adding contents and discharging contents therefrom; and,
an interior coating disposed on the interior surface.

8. The concrete mixer of claim 7, wherein the interior coating formed form flexible, abrasion resistant material.

9. The concrete mixer of claim 8, wherein the interior coating formed from material selected from the group consisting of polyurea, elastomeric urethanes, modified and hybrid epoxies that are glass flake reinforced, modified and hybrid epoxies containing polytetrafluoroethylene type fillers and ceramic epoxy coating systems.

10. The concrete mixer of claim 7, including a mixing fin mounted on the interior surface of the hollow tank.

11. The concrete mixer of claim 10, wherein the mixing fin is coated with the interior coating.

12. The concrete mixer of claim 7, wherein the tank is mounted on a mobile platform.

13. A method for enabling the clean out of a concrete mixer comprising:
providing a hollow tank having an interior surface and at least one opening for adding and discharging contents therefrom;
applying a coating to the interior surface of the tank; and,
allowing the coating to cure before adding contents to the tank.

14. The method of claim 13, wherein the step of applying includes spraying the coating on the interior surface of the tank.

15. The method of claim 13, wherein the coating is selected from a group consisting of polyurea, elastomeric urethanes, modified and hybrid epoxies that are glass flake reinforced, modified and hybrid epoxies containing polytetrafluoroethylene type fillers and ceramic epoxy coating systems.

16. The method of claim 13, including the steps of providing a mixing fin and mounting the fin on the interior surface of the tank.

17. The method of claim 16, including the step of applying the coating to the mixing fin.
